(19) United States
(12) Patent Application Publication
(10) Pub. No.: US 2005/0001205 A1
(43) Pub. Date: Jan. 6, 2005

(54) Neutron shielding material for maintaining sub-criticality based on unsaturated polymer

(76) Inventors: Pierre Malalel, It Medard en Jalles (FR); Martine Valiere, Puteaux (FR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/490,714

(22) PCT Filed: Sep. 27, 2002
(86) PCT No.: PCT/FR02/03307

(30) Foreign Application Priority Data
Oct. 1, 2001 (FR) 01/12592

(51) Int. Cl. C09K 3/00

(52) U.S. Cl. 252/478

(57) ABSTRACT

The invention concerns a neutron shielding material for maintaining sub-criticality based on unsaturated polymer: Said material comprises an unsaturated polyester resin, at least an inorganic boron compound, and at least a hydrogenated inorganic compound, in amounts such that the boron concentration is 4.10²¹ to 25.10²¹ atoms per cm³ and the hydrogen concentration is 3.10²² to 5.5.10²² atoms per cm³.

### TECHNICAL FIELD

The present invention relates to a material for neutron-shielding and for maintaining sub-criticality. Such materials are useful in nuclear energy for protecting the operatives against the neutron radiation emitted by radioactive products and for preventing runaway of the neutron-forming chain reaction, more particular when these products contain fissile materials.

They may be used in particular as neutron screens in packagings for transportation and/or storage of radioactive products, for example nuclear fuel assemblies.

For neutron shielding, it is necessary to slow down the neutrons and thus to use highly hydrogenated materials, incorporating therein a boron compound to ensure uptake of the neutrons.

To maintain sub-criticality, it is necessary to have a high content of neutron absorber in order to prevent runaway of the neutron-forming chain reaction.

Furthermore, it is necessary for these materials to be self-extinguishable.

### PRIOR ART

Neutron-shielding materials obtained from a mixture of a high-density mineral material and a thermosetting resin have been described in EP-A-0 628 968 [1]. In this document, the thermosetting resin may be an unsaturated polyester resin and the mineral fillers may be heavy metals or compounds thereof. Thus, this document does not envisage the addition of boron compounds. The preferred thermosetting resin is an epoxy resin.

Document GB-A-1 049 890 [2] describes neutron-absorbing coatings or moulded articles comprising at least 0.3% by weight of boron, obtained from a copolymerizable blend of an unsaturated polyester and of an unsaturated monomer in which either the acidic component of the polyester is partially derived from boric acid, or the polymerizable monomer is partially a boric acid ester. Preferably, the boron content is from 0.3% to 5% by weight. This boron content remains insufficient to efficiently ensure the absorption of neutrons. Moreover, this material is not self-extinguishable.

Document JP-A-55 119099 [3] describes materials for protecting against neutrons. Such a material has a hydrogen atom density of 6.1×1022 hydrogen atoms per cm³, but does not comprise a neutron absorber. Thus, it cannot ensure maintenance of the sub-criticality of a nuclear fuel transportation packaging.

### DESCRIPTION OF THE INVENTION

A subject of the present invention is, specifically, a neutron-shielding material which allows maintaining sub-criticality by means of the presence of a boron compound in sufficient amount.

According to the invention, the material for neutron-shielding and for maintaining sub-criticality comprises an unsaturated polyester resin, at least one boron mineral compound and at least one hydrogenated mineral compound in amounts such that the boron concentration is from 4×10²¹ to 25×10²¹ and preferably from 9×10²¹ to 15×10²¹ atoms per cm³ and the hydrogen concentration is from 3×10²² to 5.5×10²² and preferably from 4×10²² to 5×10²² atoms per cm³.

According to the invention, the unsaturated polyester resin may be of various types. In general, resins obtained by polycondensation of one or more diacids with one or more glycols are used, at least one of the constituents containing an ethylenic double bond capable of subsequently reacting with a vinyl, acrylic or allylic compound.

Examples of such resins that may be mentioned include the following polyesters:
the resin M0070C sold by Cray Valley Total, which is a resin based on a maleic acid and propylene glycol, crosslinked with styrene;
unsaturated polyester resins based on isophthalic or orthophthalic acid and neopentyl glycol, such as Crystic from Scott Bader; and
unsaturated polyester resins based on bisphenol A and fumaric acid units, for instance the Atlac resins sold by DSM.

It is also possible to use the resins obtained from common polyols such as propylene glycol, dipropylene glycol, diethylene glycol and oxyethylated or oxypropylated polyols such as oxyethylenated ethylene glycol and unsaturated diacids such as maleic anhydride, citraconic acid, metaconic acid and itaconic acid, or saturated diacids such as phthalic anhydride and its chlorinated or brominated derivatives.

In the material of the invention, these resins have been converted into a thermoset material by reaction with a copolymerization monomer such as styrene and styrene derivatives, for instance methylstyrene and divinylbenzene.

According to the invention, the boron mineral compound and the hydrogenated mineral compound and the amounts thereof are chosen so as to obtain boron and hydrogen concentrations that are within the ranges indicated above.

The boron compounds that may be used belong to the group comprising boric acid H₃BO₃, colemanite Ca₂O₁₄B₆H₁₀, zinc borates Zn₂O_{14.5}H₇B₆, Zn₄O₈B₂H₂ and Zn₂O₁₁B₆, boron carbide B₄C, boron nitride BN and boron oxide B₂O₃.

Preferably, the composite material of the invention comprises two boron mineral compounds, one of which is hydrogenated, for example zinc borate Zn₂O_{14.5}H₇B₆ or Zn₄O₈B₂H₂ or Zn₂O₁₁B₆, and boron carbide.

The hydrogenated mineral compounds that may be used preferably belong to the group of alumina hydrates and magnesium hydroxide. Alumina hydrate Al(OH)₃ is preferably used.

The material of the invention may also comprise poly(vinyl acetate) to give the material a shrink-proof nature.

It may also comprise a hydrogenated organic filler such as melamine, to improve its self-extinguishability properties.

In the material of the invention, the amounts of the various constituents are also chosen so as to obtain density, self-extinguishability and thermal conductivity properties that are suitable for use in a packaging for transporting and/or storing radioactive material.

In particular, it is necessary to have good ageing properties, at a relatively high temperature, since the products placed in the packaging can reach a temperature of 150° C.

It is also necessary for the material to be fire-resistant, which assumes that it is self-extinguishable, i.e. the fire stops when the flame is put out; it therefore does not feed the fire.

According to the invention, this self-extinguishability property is imparted in particular by the presence of hydrogen-containing and/or boron-containing mineral compounds, for example alumina hydrate or zinc borate. The self-extinguishability nature may also be imparted by the presence of melamine.

Similarly, the material should have a thermal conductivity that is low but sufficient to remove heat from the transported elements such as irradiated fuel elements.

Finally, as will be seen later, given that this material is obtained by casting a mixture of the various constituents and of a vinyl diluent, it is important for the amounts of the various constituents to be such that the mixture has the property of being able to be cast.

By way of example of a composition of material in accordance with the invention, mention may be made of the material comprising 25% to 40% by weight of thermoset unsaturated polyester resin, i.e. including the vinyl diluent, for example styrene.

Preferably, according to the invention, the material has a density of greater than or equal to 1.7, for example from 1.7 to 1.85.

In order to obtain good properties of maintenance of sub-criticality, the boron content is preferably at least 9.4×1021 boron atoms per cm³.

The material of the invention may be prepared by curing a mixture of the constituents in the unsaturated polyester resin in solution in a vinyl diluent.

Thus, a subject of the invention is also a process for preparing the neutron-shielding material described above, which consists in preparing a mixture of the unsaturated polyester resin in solution in a vinyl diluent with the boron mineral compound(s) and the hydrogenated mineral compound(s), adding to the mixture a catalyst and a curing accelerator, casting the mixture in a mould and leaving it to cure in the mould.

The vinyl diluent may be, for example, styrene, vinyltoluene, divinylbenzene, methylstyrene, methyl acrylate, methyl methacrylate or an allylic derivative such as diallyl phthalate. Preferably, styrene is used, which makes it possible both to dissolve the unsaturated polyester resin and to cure it by copolymerization.

The catalysts and curing accelerators used are chosen from the compounds usually used for curing unsaturated polyesters.

The catalysts may be, in particular, organic peroxides, for example:
ketone-based peroxides, for instance methyl ethyl ketone peroxide, acetylacetone peroxide, methyl isobutyl ketone peroxide and cyclohexanone peroxide;
diacyl peroxides, for example benzoyl peroxide optionally in combination with aromatic tertiary amines such as dimethylaniline, diethylaniline and dimethyl-para-toluidine; and
dialkyl peroxides such as dicumyl peroxide and di-tert-butyl peroxide.

The accelerators most commonly used are divalent cobalt salts, for instance cobalt naphthenate or octoate, and aromatic tertiary amines such as diemthylaniline, dimethyl-para-toluidine and diethylaniline.

One or more additives such as crosslinking inhibitors, surfactants and shrink-proofing agents may also be added to the mixture.

According to the invention, the mould used for curing the resin may consist directly of the packaging for transporting and/or storing radioactive products. By way of example, the packaging may comprise two concentric walls, for example two steel ferrules, between which the mixture is cast before curing. The packaging may also comprise peripheral housings into which the mixture is cast.

Other characteristics and advantages of the invention will emerge more clearly on reading the description that follows, of examples of embodiments given, of course, for illustrative purposes and in a non-limiting manner, with reference to the attached drawings.

### BRIEF DESCRIPTION OF THE DRAWINGS

FIG. 1 shows the loss of mass (in %) at 50° C. of a material in accordance with the invention, as a function of time (in hours).

FIG. 2 shows the loss of mass (in %) at 150° C. of a material in accordance with the invention, as a function of time (in hours).

### DETAILED DESCRIPTION OF THE EMBODIMENTS

The examples that follow illustrate the manufacture of composite materials for neutron-shielding and for maintaining sub-criticality, charged with boron carbide, using, as unsaturated polyester resin, the resin sold by Cray Valley under the name Norsodyne M0070C.

### EXAMPLE 1

A polymerization mixture is prepared from the unsaturated polyester resin Norsodyne M0070C, which is in solution in styrene, poly(vinyl acetate) PVAC, zinc borate Zn₂O_{14.5}H₇B₆, colemanite, boron carbide and alumina hydrate, using proportions given in Table 1. The following constituents are added to the mixture:
0.85 g/kg of mixture of the accelerator NL 51P sold by Akzo Nobel,
0.60 g/kg of mixture of the inhibitor TC 510 sold by the Arnaud group,
0.30 g/kg of mixture of the amine NL 63-10 sold by Akzo Nobel,
9.3 g/kg of mixture of the surfactant BYK W980 sold by Byk Chimie, and
8.5 g/kg of mixture of the catalyst Butanox M50 (methyl ethyl ketone peroxide).

The resin is then cured. To do this, it is necessary to preheat the mixture to 45° C. The mixture is then degassed under vacuum for 4 minutes, after which it is cast into a mould heated to 100° C. and placed under a negative pressure (−0.3 bar) in order to facilitate the filling and to reduce the casting time.

In this example, the mould consists of a packaging for transporting nuclear fuels, comprising:
an outer ferrule made of stainless steel sheet,
an inner ferrule made of stainless steel sheet, and
a flat base made of stainless steel sheet.

The space between the two concentric ferrules, which is at least 18 mm thick, is intended for casting the polymerizable mixture. This space, closed at its top end, comprises on this end two diametrically opposite holes. One of the holes is connected to an addition funnel and the other hole is connected to a vacuum pump to create a negative pressure of −0.3 bar during casting.

After filling, the mould is placed in an oven at 100° C. for 4 hours.

A composite material having the following properties is thus obtained:
density: 1.7,
hydrogen content: 3.9% by weight, i.e. 4×10²² atoms/cm³,
boron content: 9.9% by weight, i.e. 9.4×10²¹ atoms/cm³.

### EXAMPLE 2

The same procedure as in Example 1 is followed, using the constituents and proportions given in Table 1.

The mixture also comprises:
-0.7% of the weight of resin+styrene, of the accelerator NL 49P sold by Akzo Nobel, and

1.8% of the weight of resin+styrene, of the catalyst Cyclonox LR sold by Akzo Nobel.

TABLE 1

| | Example 1 | Example 2 | Example 3 |
|---|---|---|---|
| Constituents | (% by weight) | (% by weight) | (% by weight) |
| Unsaturated | 29 | 32.7 | 27 |
| polyester M0070C | | | |
| Added Styrene | | 4.75 | 5 |
| Zinc borate | 23 | 33.6 | 13 |
| Colemanite | 27.7 | | |
| Ca₂O₁₄B₆H₁₀ | | | |
| Boron carbide B₄C | 4.3 | 6.55 | 15 |
| Alumina hydrate | 7 | 22.4 | 40 |
| Al(OH)₃ | | | |
| PVAC | 9 | | |

In this case, the curing is performed at room temperature and, after 20 to 30 minutes, a material having the following characteristics is obtained:
density: 1.77,
hydrogen content: 3.9% by weight, i.e. 4.1×1022 at/cm³,
boron content: 10.1% by weight, i.e. 10×1021 at/cm³.

The material obtained has satisfactory thermal properties.

Its glass transition temperature Tg, determined by TMA (Mettler) with a temperature rise of 10° C./minute, is about 145° C.

The glass transition temperature has an appreciable influence on the thermomechanical behaviour since, above this temperature, the material has rubbery behaviour.

The measurement of the coefficient of expansion, measured by TMA (Mettler) with a temperature rise of 10° C./minute, gives for the material:
before the T_{g} temperature: 51.2×10⁻⁶ K⁻¹, and
after the T_{g} temperature: 93.3×10⁻⁶ K^{-1.}

The specific heat is measured by differential thermal analysis (DSC30, Mettler), with a rate of temperature rise of 10° C./minute, over a temperature range from 25° C. to 200° C. The results obtained are given in Table 2.

TABLE 2
Specific heat as a function of the temperature

| Temperature (° C.) | Cp (J.g⁻¹ · ° C.⁻¹) |
|---|---|
| 30 | 0.0269 |
| 40 | 1.07 |
| 50 | 1.13 |
| 60 | 1.17 |
| 70 | 1.23 |
| 80 | 1.28 |
| 90 | 1.33 |
| 100 | 1.38 |
| 110 | 1.42 |
| 120 | 1.46 |
| 130 | 1.50 |
| 140 | 1.53 |
| 150 | 1.57 |
| 160 | 1.60 |
| 170 | 1.64 |
| 180 | 1.67 |
| 190 | 1.69 |
| 200 | 1.71 |

Thermal conductivity measurements are also taken for temperatures of between 200C and 185° C. Over this temperature range, the thermal conductivity value of the resin is in the region of 0.55 W/m.K. The values obtained are given in Table 3.

TABLE 3
Conductivities at various temperatures

| Temperature (° C.) | λ(W/m · K) |
|---|---|
| 25 | 0.531 |
| 30 | 0.540 |
| 50 | 0.564 |
| 75 | 0.590 |
| 100 | 0.623 |
| 125 | 0.641 |
| 150 | 0.646 |
| 170 | 0.632 |
| 185 | 0.629 |

The mechanical properties of the material are also determined by performing compression tests at temperatures of −40, +23 and +150° C. The modulus of compression of the material may thus be determined, and the results obtained are given in Table 4.

TABLE 4

Modulus of compression in MPa

| Temperature in ° C. | Free | In conformator |
|---|---|---|
| −40 | 4693 ± 30.7 | 3973 ± 127 |
| 23 | 5260 ± 187 | 5333 ± 165 |
| 150 | 1855 ± 321 | 3360 ± 81 |

Tests of thermal ageing of the material at 50° C. and at 150° C. are also performed.

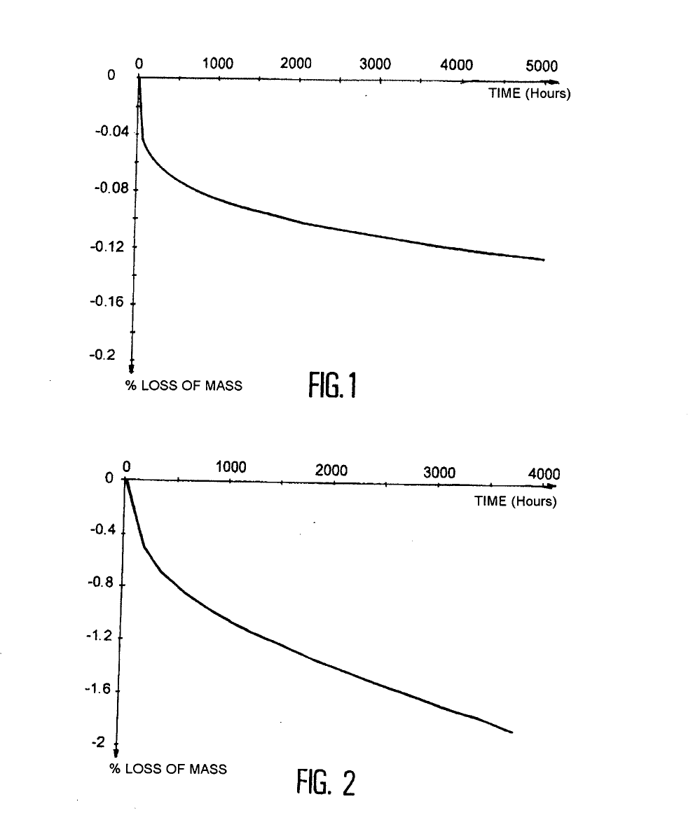

The tests of ageing at 50° C. over 6 months consist in placing samples of the material 25×36×100 mm in size in an oven at 50° C. and in monitoring the loss of mass of these samples over time. The curve of the change in the loss of mass of the material (in %) as a function of time (in hours) is shown in FIG. 1.

Thermal ageing tests at 150° C. are also performed, the samples being identical in size.

FIG. 2 shows the loss of mass (in %) of this material, at 150° C., as a function of time (in hours).

Tests of fire resistance of this material were also performed on samples 400×300×20 mm in size. For this test, the material is rated “M1”, which is very satisfactory.

A fire test of half an hour at 800° C. was also performed on two blocks 240 mm in diameter and 60 mm in height. For the first block, the flame was directly in contact with the material, whereas the second block was protected with a stainless steel sheet 1 mm thick.

For the first test, the self-extinguishability of the resin is immediate after removal of the torch. Furthermore, the thickness of carbonized material is 9 mm.

For the second test, the thickness of carbonized material is 2 mm.

### EXAMPLE 3

The same procedure as in Example 1 is followed in order to prepare a material for neutron-screening and for maintaining sub-criticality, using the constituents and proportions given in Table 1 and recalled hereinbelow:
unsaturated polyester M0070C: 27% by weight
added styrene: 5% by weight
zinc borate: 13% by weight
boron carbide B₄C: 15% by weight
alumina hydrate Al(OH)₃: 40% by weight

The mixture also comprises:
0.7% of the weight of resin+styrene of the accelerator NL 49 P sold by Akzo Nobel,
1.8% of the weight of resin+styrene of the catalyst Cyclonox LR sold by Akzo Nobel, and
9.3 g/kg of mixture of the surfactant BYK W980 sold by Byk Chimie.

A material having the following characteristics is obtained:
density: 1.83
hydrogen content: 3.9% by weight, i.e. 4.1×10²² at/cm³
boron content: 13.7% by weight, i.e. 13.3×10²¹ at/cm³.

Thus, the material of the invention has properties that are very advantageous for neutron shielding and for maintaining sub-criticality during the transportation of irradiated nuclear fuel assemblies.

### CITED REFERENCES

[1] EP-A-0 628 968
[2] GB-A-1 049 890
[3] JP-A-55 119099

1. Material for neutron-shielding and for maintaining sub-criticality comprising an unsaturated polyester resin, at least one boron mineral compound and at least one hydrogenated mineral compound in amounts such that the boron concentration is from 4×10²¹ to 25×10²¹ atoms per cm³ and the hydrogen concentration is from 3×10²² to 5.5×10²² atoms per cm³.

2. Material according to claim 1, in which the amounts of boron mineral compound and of hydrogenated mineral compound are such that the boron concentration is from 9×10²¹ to 15×10²¹ atoms per cm³ and the hydrogen concentration is from 4×10²² to 5×10²² atoms per cm³.

3. Material according to claim 1, in which the boron mineral compound is chosen from the group consisting of boric acid H₃BO₃, zinc borates Zn₂O_{14.5}H₇B₆, Zn₄O₈B₂H₂ and Zn₂O₁₁B₆, colemanite Ca₂O₁₄B₆H₁₀, boron carbide B₄C, boron nitride BN and boric oxide B₂O₃.

4. Material according to claim 1, comprising two boron mineral compounds consisting of a zinc borate and boron carbide.

5. Material according to claim 1, in which the hydrogenated mineral compound is chosen from the group of alumina hydrates and magnesium hydroxide.

6. Material according to claim 5, in which the hydrogenated mineral compound is an alumina hydrate.

7. Material according to claim 1, also comprising poly(vinyl acetate).

8. Material according to claim 1, also comprising a hydrogenated organic filler to improve the self-extinguishability properties of the material.

9. Material according to claim 1, comprising 25% to 40% by weight of thermoset unsaturated polyester resin comprising a vinyl diluent.

10. Material according to claim 1, which has a density of greater than or equal to 1.7 and preferably from 1.7 to 1.85.

11. Material according to claim 1, which comprises at least 9.4×10²¹ boron atoms per cm³.

12. Process for preparing a neutron-shielding material according to claim 1, which consists in preparing a mixture of the unsaturated polyester resin in solution in a vinyl diluent with the boron mineral compound(s) and the hydrogenated mineral compound(s), adding to the mixture a catalyst and a curing accelerator, casting the mixture in a mould and leaving it to cure in the mould.

13. Process according to claim 12, in which the vinyl diluent is styrene.

14. Process according to claim 12, in which the mould is a packaging for transporting and/or storing radioactive products.

15. Packaging for transporting or storing radioactive products, comprising a neutron shield made of a material according to claim 1.
